(19) United States
(12) Patent Application Publication
(10) Pub. No.: US 2016/0355374 A1
(43) Pub. Date: Dec. 8, 2016

(54) CABLE ORGANIZER APPRATUSES AND RELATED METHODS

(71) Applicant: Syneco, LLC, Greenville, SC (US)

(72) Inventor: Jay C. Sinnett, Greenville, SC (US)

(21) Appl. No.: 15/173,651

(22) Filed: Jun. 4, 2016

Related U.S. Application Data
(60) Provisional application No. 62/172,001, filed on Jun. 5, 2015.

(51) Int. Cl. B65H 75/44; F16L 3/10; F16L 3/16; F16L 3/06

(52) U.S. Cl. CPC B65H 75/4473; F16L 3/06; F16L 3/1075; F16L 3/16; B65H 2701/34

(57) ABSTRACT

A cable organizer apparatuses and related methods are disclosed herein. A cable organizer can include a holding chamber configured to hold at least a portion of a cable therein. The cable organizer can also include a first retaining assembly disposed adjacent the holding chamber. The first retaining assembly can be configured to hold a first end of the cable therein. Similarly, the cable organizer can include a second retaining assembly adjacent the holding chamber. The second retaining assembly cab be configured to hold a second end of the cable therein. The use of separate retaining assemblies, each isolated from the holding chamber, enables the user to avoid creating knots in the cable (or rope, hose, etc.).

### RELATED APPLICATIONS

The presently disclosed subject matter claims the benefit of U.S. Provisional Patent Application Ser. No. 62/172,001, filed Jun. 5, 2015; the disclosure of which is incorporated herein by reference in its entirety.

### TECHNICAL FIELD

The present subject matter relates to cable organizer apparatuses and related methods. In particular, the present subject matter relates to cable organizer apparatuses that can be used primarily to facilitate the storage of cables, such as extension cords, hoses, ropes, or the like, in a manner that prevents the knotting of the cable.

### BACKGROUND

It is a common problem with cables, such as cords, hoses, ropes, or the like, for them to become tangled upon themselves during storage. For example, there is a tendency to wrap an extension cord around an arm of a user and then tied off at one end. However, if the ends of the extension cord are not maintained and are allowed to dangle, the likelihood of an end of the extension cord passing through a loop of the wrapped extension cord and the extension cord becoming knotted increases.

While different devices have been developed to maintain the integrity of a long cable, such as an extension cord, for storage, a need still exists for a device that can cheaply and effectively maintain the integrity of a looped cable to allow for easy maintenance and storage as well as easy distribution of the cable in times of use without causing the cable to become twisted or knotted.

### SUMMARY

The present subject matter provides cable organizer apparatuses and related methods. In particular, the present subject matter relates to cable organizer apparatuses that can be used primarily to facilitate the storage of cables, such as extension cords, hoses, ropes, or the like, in a manner that prevents the knotting of the cable. Methods related to the manufacture and use of the cable organizer apparatuses disclosed herein are also provided.

Thus, it is an object of the presently disclosed subject matter to provide cable organizer apparatuses as well as methods related thereto. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1A illustrates a top perspective view of an embodiment of a cable organizer apparatus according to the present subject matter having a securement strap closing a holding chamber of the cable organizer apparatus;

FIG. 1B illustrates a top plan view of the embodiment of the cable organizer apparatus according to FIG. 1A;

FIG. 1C illustrates a side view of the embodiment of the cable organizer apparatus according to FIG. 1A;

FIG. 1D illustrates an end view of the embodiment of the cable organizer apparatus according to FIG. 1A;

FIG. 1E illustrates a top perspective view of the embodiment of the cable organizer apparatus according to FIG. 1A including an embodiment of a securement strap used to hold a cable within the holding chamber;

FIG. 2A illustrates a top perspective view of an additional embodiment of a cable organizer apparatus according to the present subject matter;

FIG. 2B illustrates a top plan view of the embodiment of the cable organizer apparatus according to FIG. 2A;

FIG. 2C illustrates a side view of the embodiment of the cable organizer apparatus according to FIG. 2A;

FIG. 2D illustrates a vertical cross-sectional side view of the embodiment of the cable organizer apparatus according to FIG. 2A showing interior surfaces in hatched lines;

FIG. 2E illustrates a perspective view of the embodiment of the cable organizer apparatus holding a cable within a holding chamber of the cable organizer apparatus according to FIG. 2A;

FIG. 3A illustrates a top perspective view of another embodiment of a cable organizer apparatus according to the present subject matter;

FIG. 3B illustrates an exploded side view of the embodiment of the cable organizer apparatus according to FIG. 3A;

FIG. 3C illustrates a side view of the embodiment of the cable organizer apparatus according to FIG. 3A;

FIG. 3D illustrates a top plan view of the embodiment of a base of the cable organizer apparatus with an enclosure arm removed according to FIG. 3A;

FIG. 3E illustrates a bottom front perspective view of an embodiment of an enclosure arm of the embodiment of the cable organizer apparatus according to FIG. 3A;

FIG. 3F illustrate perspective views of the embodiment of the cable organizer apparatus holding a cable within a holding chamber of the cable organizer apparatus according to FIG. 3A;

FIG. 4A illustrates a top perspective view of a further embodiment of a cable organizer apparatus according to the present subject matter;

FIG. 4B illustrates a side view of the embodiment of the cable organizer apparatus according to FIG. 4A;

FIG. 4C illustrates a top plan view of the embodiment of the body of the cable organizer apparatus according to FIG. 4A;

FIG. 4D illustrates an end plan view of an embodiment of an enclosure arm of the embodiment of the cable organizer apparatus according to FIG. 4A;

FIG. 4E illustrate perspective views of the embodiment of the cable organizer apparatus holding a cable within a holding chamber of the cable organizer apparatus according to FIG. 4A.

Repeat use of reference characters in the present specification and drawings is intended to represent the same or analogous features or elements of the present subject matter.

Other documentation and related information are provided herewith to further illustrate these and other aspects of the subject matter disclosed herein and to further provide disclosure that is enabling to one of ordinary skill in the art.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer or section. Thus, a first feature, element, component, region, layer or section discussed below could be termed a second feature, element, component, region, layer or section without departing from the teachings of the disclosure herein.

Similarly, when a feature is being described in the present disclosure as “on” or “over” another feature, it is to be understood that the features can either be directly contacting each other or have another feature or space between the features, unless expressly stated to the contrary. Thus, these terms are simply describing the relative position of the features to each other and do not necessarily mean “on top of” since the relative position above or below depends upon the orientation of the apparatus to the viewer.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

“Holding chamber” as used herein means a geometric shape that can hold at least a portion, such as loops, of a cable with the holding chamber forming sides of a closed figure surrounding an opening when the outline of the device or apparatus is projected onto a plane essentially perpendicular to the intended direction of the cables passing through the device apparatus.

“Cables” as used herein includes but are not limited to cords, electric cords, hoses, ropes, or the like.

“Permanent attachment” as used herein means an attachment in which the manufacturer has integrated the cable retaining assembly with the cable in such a way that the cable cannot be separated from the retaining assembly without damaging both the cable and the retaining assembly which, for example, can include but is not limited to a retaining assembly molded on to the cable to become an integral part of the cable.

“Semi-permanent attachment” as used herein means an attachment in which the cable can be removed from the retaining assembly without damaging the cable, but such removal causes damage to the retaining assembly which would require replacement parts or other repairs to restore the retaining assembly to its original state.

The primary motivation for the development of the cable organizer apparatuses described herein is to solve the problem with coiled cables developing knots when they are deployed. The technology relies on a topological property: if both ends of a length of cable (hose, rope, etc.) are captured relative to each other, then while they are so captured no new knots can form in the cable between the captured points.

In practical use, it is intended that the user will use a cable organizer apparatus to capture one end of the cable in a first retaining assembly, then wind up coils of cable into the holding chamber between the holding walls of the cable organizer apparatus, and then capture the other end of the cable into a second retaining assembly. In some embodiments as described below, the user can then wrap a Velcro™ strap over the coils, securing them in place within the holding chamber between the holding walls. To remove the cable, the user simply removes one end from the second retaining assembly, releases the strap, and pulls coils off from the holding chamber. The user should be careful not to allow the free end of the cable to pass through any of the loops that are being released. If the user obeys this simple rule, there will be no knots in the cable as it is removed.

In some embodiments as described below, structural integrity can be enhanced for embodiments that use a securement strap, by having the strap pass underneath the central section of the cable organizer apparatus and come up through two insertion apertures on either end of the cable organizer apparatus. However, alternative arrangements that may or may not use a securement strap, as described below, can be just as effective.

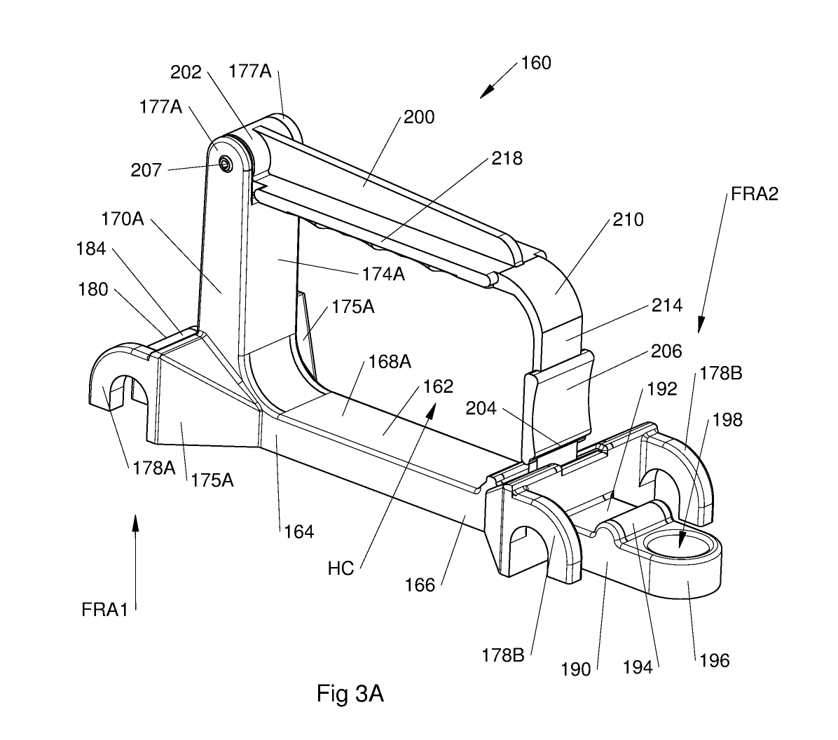

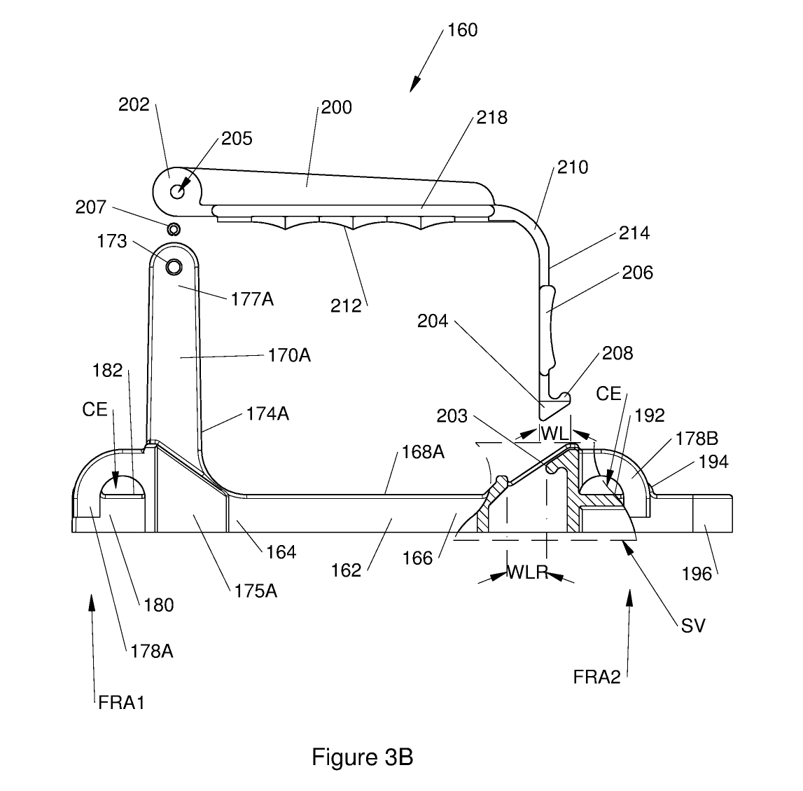

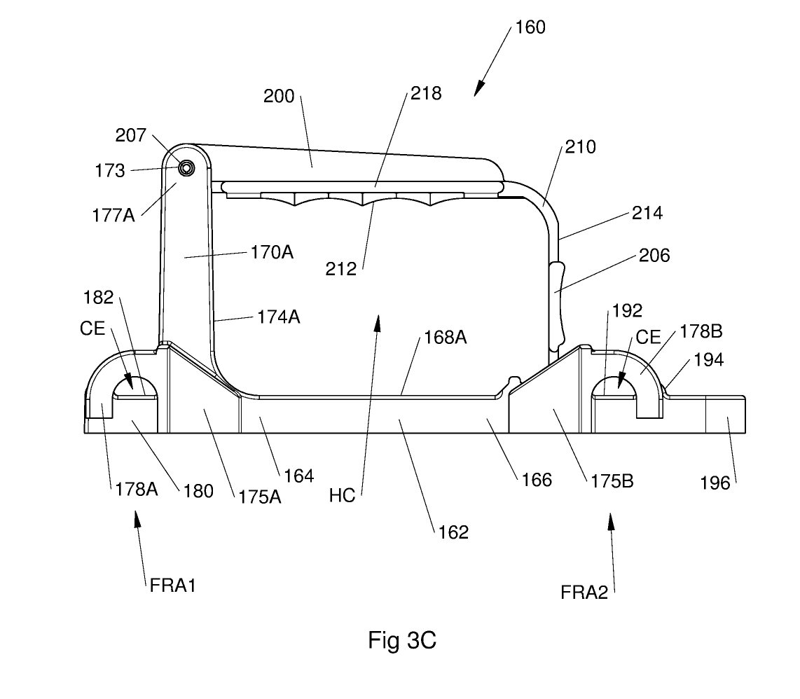

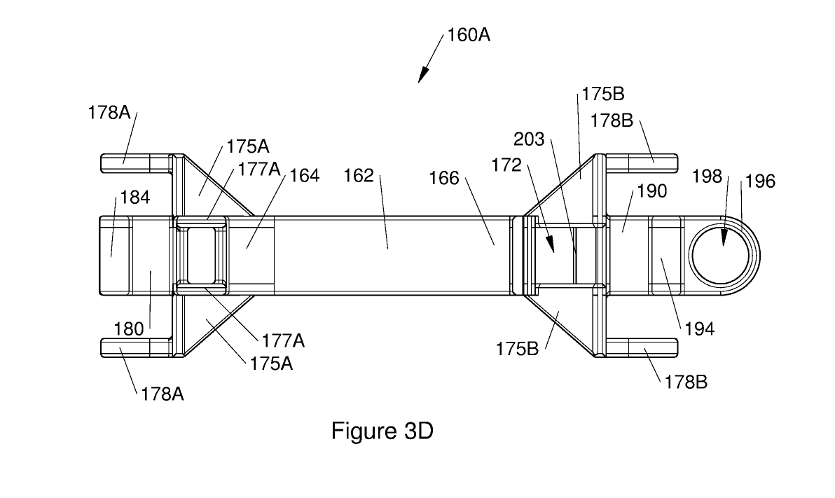

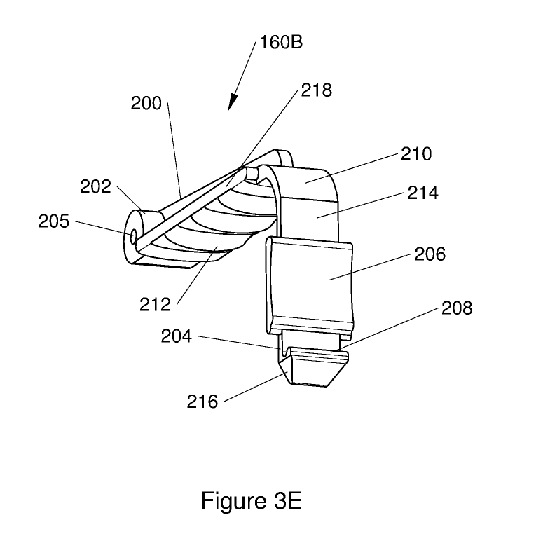

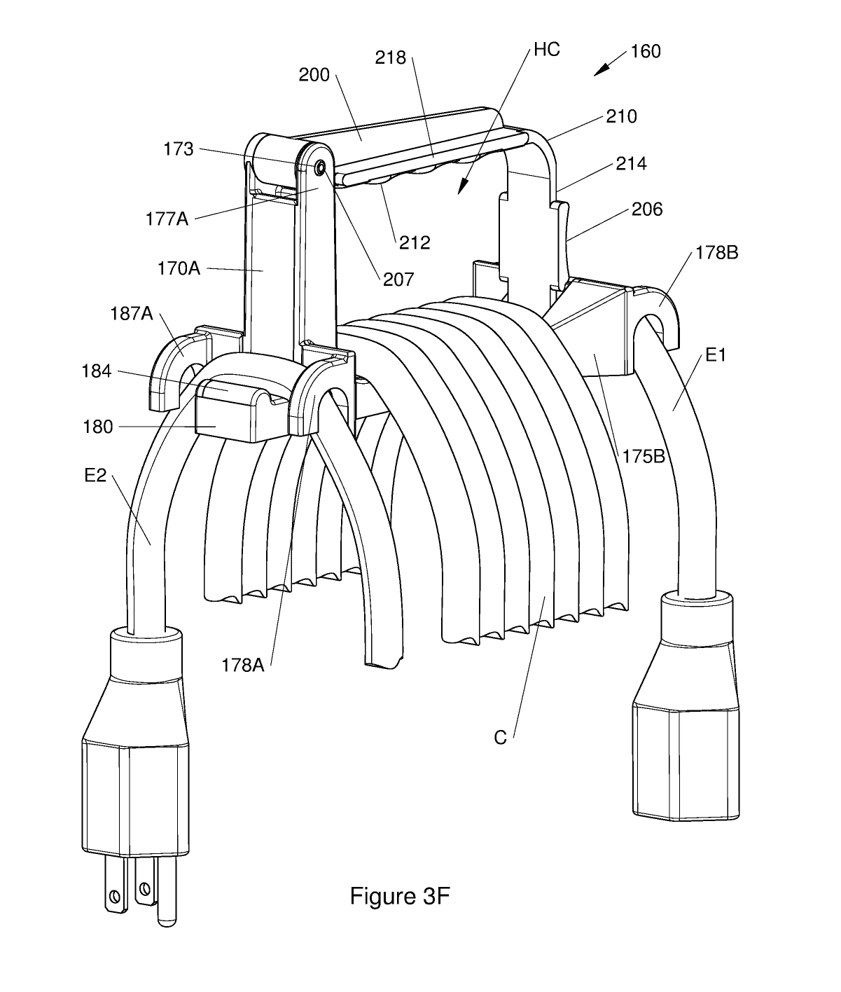

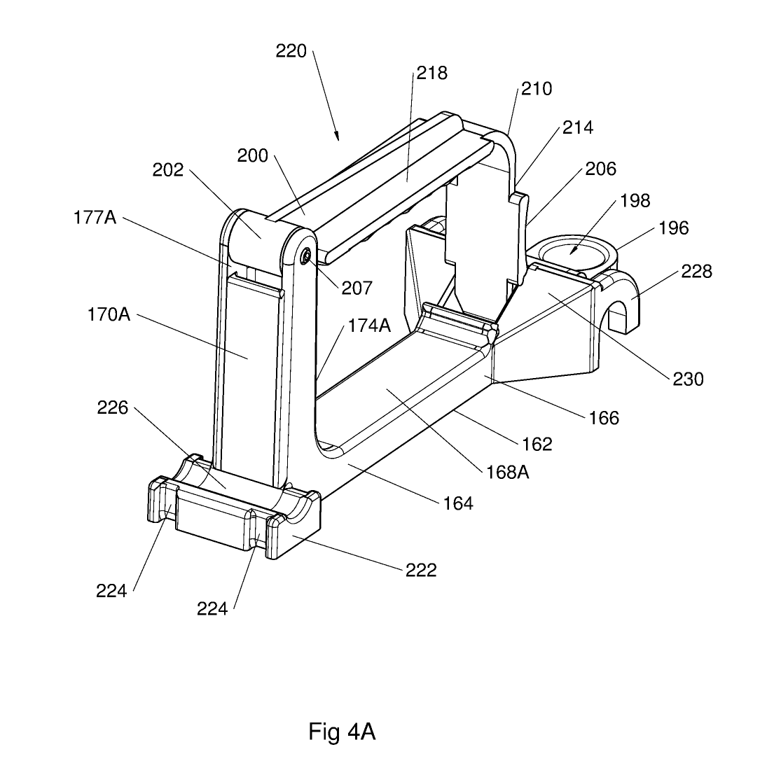

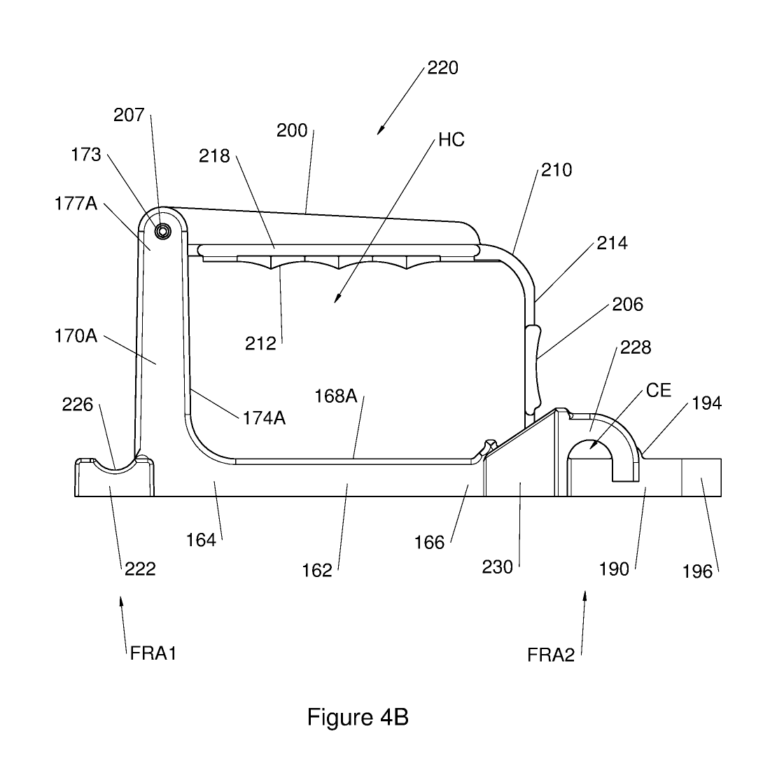

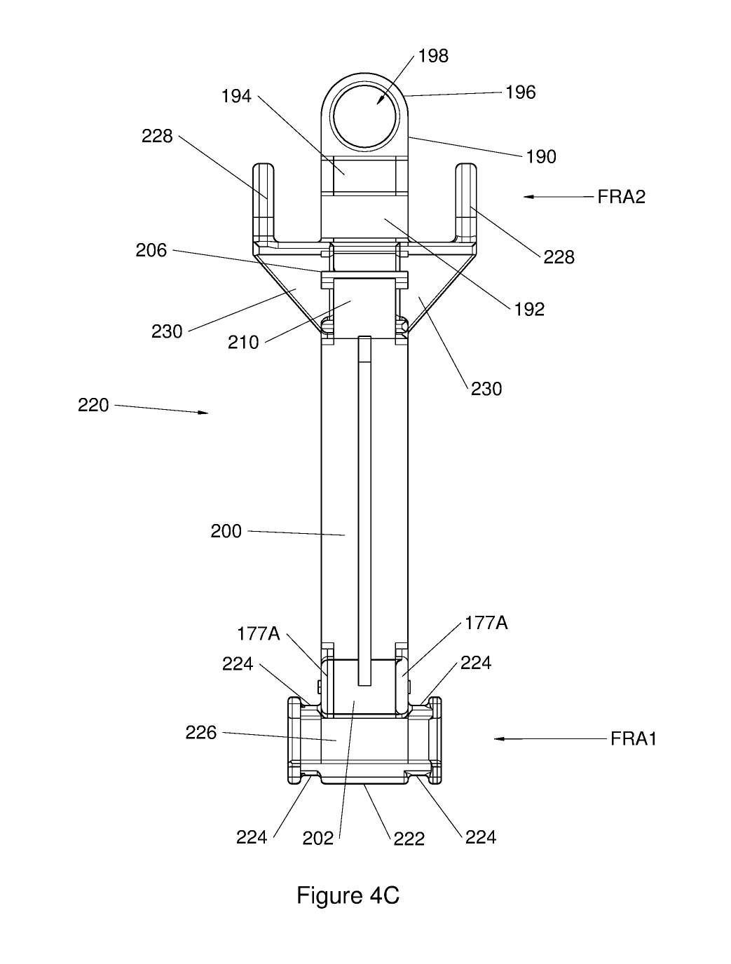

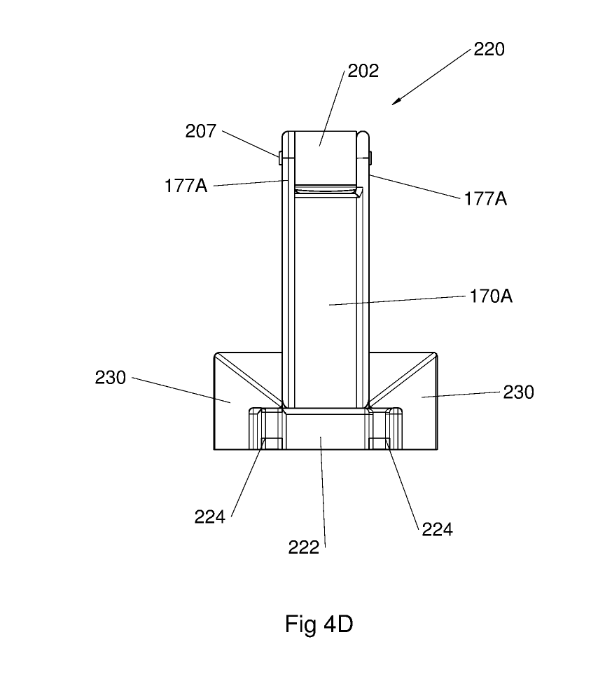

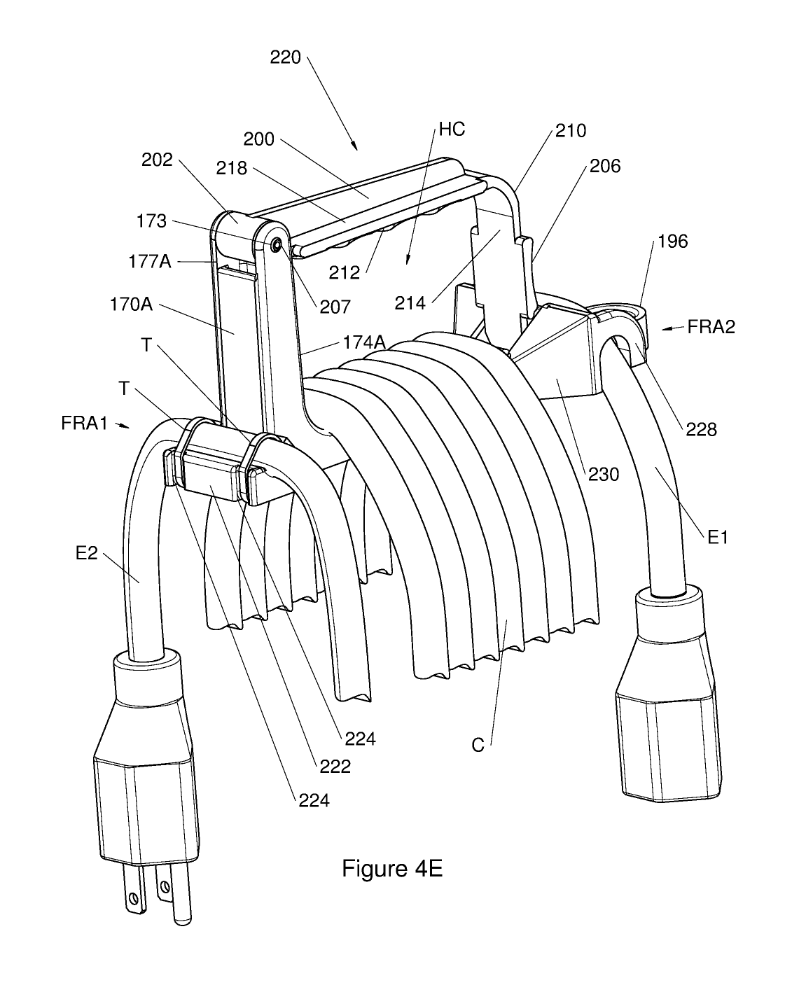

FIGS. 3F and 4E illustrate embodiments of cable organizer apparatuses generally designated 160 and 220, respectively, that are each holding a cable C, such as an extension cord, for storage and prevent knotting of the cable C from occurring. Referring to FIG. 3F, the cable organizer apparatus 160 can comprise a holding chamber HC which can hold at least a portion of a cable C, therein for maintenance and storage. For example, portions of coils of the cable C to be maintained and stored are placed in the holding chamber HC. The cable organizer 160 can also comprise a first retaining assembly FRA₁ and a second retaining assembly FRA₂ for holding or retaining a first end E₁ and second end E₂ of a cable C being held by the cable organizer apparatus 160. By holding the first and second ends E₁, E₂ of the cable C, the first retaining assembly FRA₁ and a second retaining assembly FRA₂ can help to prevent the knotting and entangling of the cable C from occurring. To hold the ends, the first and second retaining assemblies FRA₁, FRA₂ can comprise retainers that allow the first and second ends E₁, E₂ of the cable C to be inserted and removed from the first and second retaining assemblies FRA₁, FRA₂.

In some embodiments, the ends of the cable are “removably” held in retaining assemblies FRA₁ and FRA₂, which means that the ends of the cable can be inserted and held in the retaining assemblies FRA₁ and FRA₂ until the user intentions removes the ends without damage to any portion of the retaining assemblies FRA₁ and FRA₂ or the cable as shown in the embodiment of the cable organizer apparatus 160. However, in some embodiments, it may be preferable to make a semi-permanent attachment or a permanent attachment of an end of the cable to one of the retaining assemblies. For purposes of this disclosure, a permanent attachment, as defined above, is one in which the manufacturer has integrated the cable retaining assembly with the cable in such a way that the cable cannot be separated from the retaining assembly without damaging both the cable and the retaining assembly (for example, the retaining assembly is molded on to the cable to become an integral part of the cable). For purposes of this disclosure, a semi-permanent attachment, as defined above, is one in which the cable can be removed from the retaining assembly without damaging the cable, but such removal does cause damage to the retaining assembly which would require replacement parts or other repairs to restore the retaining assembly to its original state. The following discussion of FIG. 4A describes one embodiment of a “semi-permanent attachment of a retaining assembly to the cable.

In the embodiment shown in FIG. 4A, the cable organizer apparatus 220 can also comprise a holding chamber HC as well as a first retaining assembly FRA₁ and a second retaining assembly FRA₂ for holding or retaining a first end E₁ and second end E₂ of a cable C being held by the cable organizer apparatus 220. The first retaining assembly FRA₁ can comprise retainers that allow the first end E₁ of the cable C that includes the female end to be inserted and removed from the first retaining assembly FRA₁, while the second retaining assembly FRA₂ can comprise a detent in which the second end E₂ of the cable C that can include the male connection of the cable C can be securely attached by straps T, such as plastic ties, that hold the cable organizer apparatus 220 to the cable C. In this manner, the cable organizer apparatus 220 can remain with the cable C even when the cable C is unraveled from the holding chamber HC of the cable organizer apparatus 220. The cable organizer apparatus 220 can thus be used to hold and maintain a cable, such as an extension cord, for storage and prevent knotting of the extension cord from occurring. The cable organizer apparatuses 160 and 220 as well as other embodiments of cable organizer apparatuses are described in more detail below.

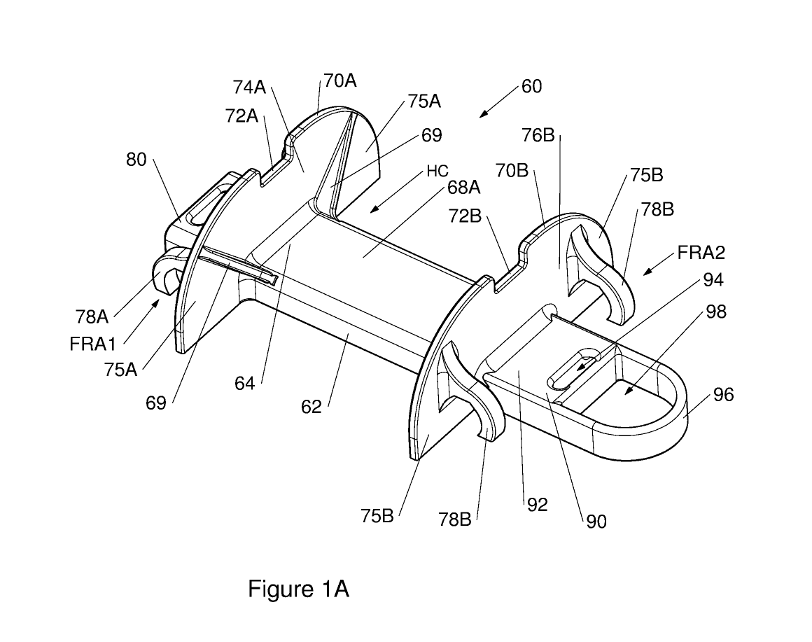

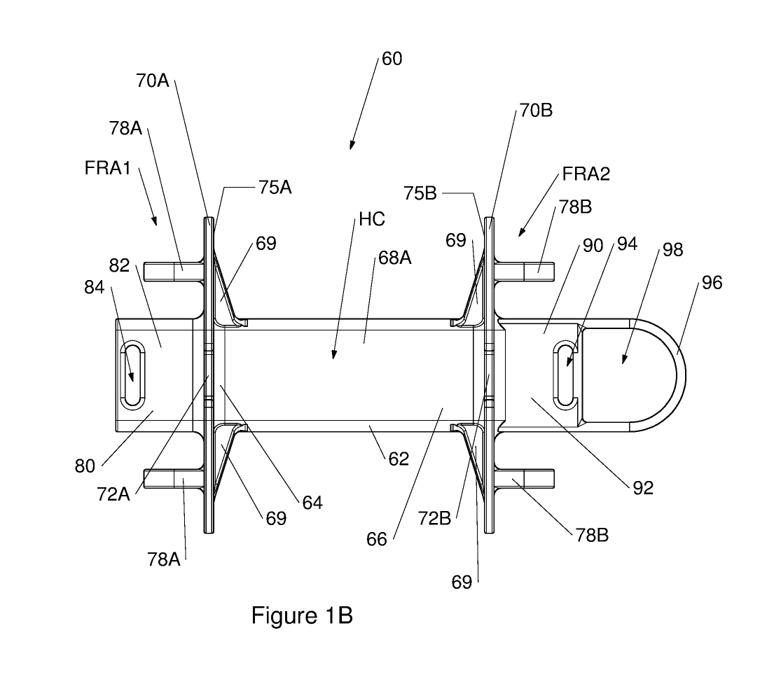

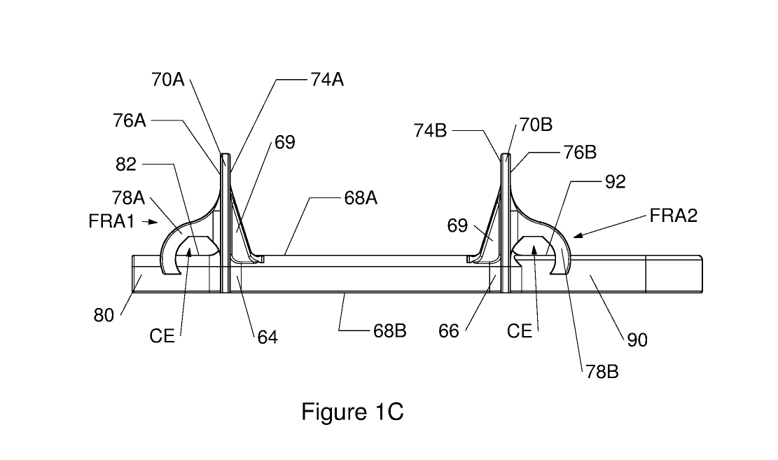

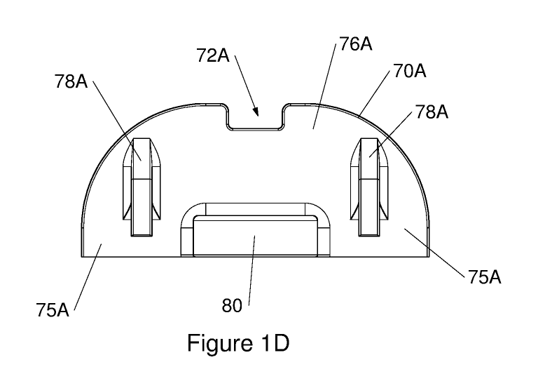

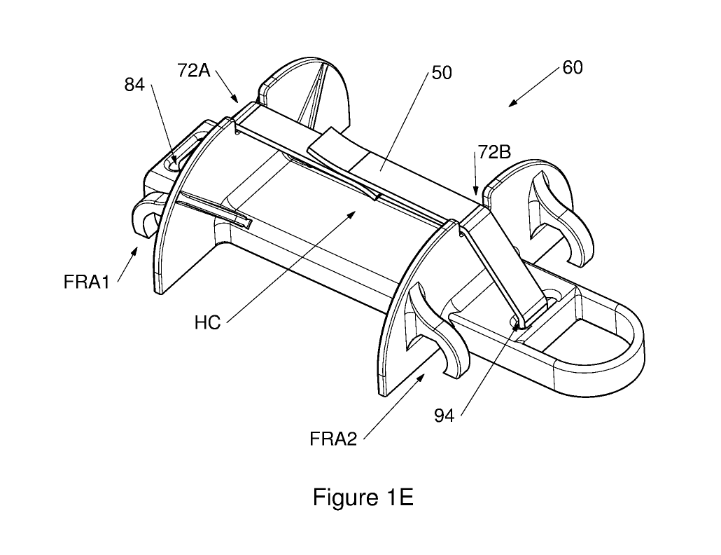

A similar embodiment of a cable organizer apparatus, generally designated 60, is shown in FIGS. 1A-1E. Cable organizer apparatus 60 can comprise a centrally located elongate body 62 that has a first end 64 and a second end 66. The elongate body 62 can also comprise a receiving side 68A that forms a base of a holding chamber HC for holding a portion of a cable therein and a back side 68B. First and second holding walls 70A, 70B can extend upward from the respective first end 64 and second end 66 of the elongate body 62 to form the sides of the holding chamber HC. In particular, the first and second holding walls 70A, 70B can have an interior side 74A, 74B that forms the sides of the holding chamber HC.

The cable organizer apparatus 60 shown in FIGS. 1A-1D can comprise first and second retention assemblies FRA₁, FRA₂, which can comprise one or more upper retention members and one or more lower retention members. For example, upper retention members can comprise hooks 78A and 78B that extend outward from exterior sides 76A and 76B of the first and second holding walls 70A and 70B. The hooks 78A and 78B can face downward toward the one or more lower retention members. For example, hooks 78A can be positioned proximal to and face downward toward a base extension 80, while hooks 78B can be positioned proximal to and extend downward toward a head extension 90. Ends of a cable being maintained and stored on the cable organizer apparatus 60 can be placed between the respective hooks 78A, 78B and the respective base extension 80 and head extension 90 to hold the ends in the first and second retention assemblies FRA₁, FRA₂. Thus, an end of the cable, such an extension cord, can be placed under the hooks 78A and overtop of a retention surface 82 of the base extension 80 so that the end extends through a path CE and the other end of the cable can be placed under the hooks 78B and overtop of a retention surface 92 of the head extension 90 so that the end extends through a similar path CE as seen in FIG. 1C. The first and second retention assemblies FRA₁, FRA₂ can hold the ends of the cable until a user removes the ends from the first and second retention assemblies FRA₁, FRA₂.

Each of the first and second holding walls 70A and 70B can have an interior side 74A and 74B, respectively. The first and second holding walls 70A and 70B along with the elongate body 62 can provide the base and sidewalls of the holding chamber HC. In particular, the receiving side 68A of the elongate body 62 can form the base of the holding chamber HC and the interior sides 64A and 64B can form the sides of the holding chamber HC. In some embodiments, the first and second holding walls 70A and 70B can extend outward radially from the elongate body 62 to form extension arms 75A and 75B, respectively, on each side of the elongate body 62. Thereby, the first and second holding walls 70A and 70B can form a semi-circular plate.

The first retaining assembly FRA₁ can comprise a plurality of retention members that can be spaced apart from each other and positioned such that the cable to be stored can have an end placed between and then held by the retention members. Similarly, the second retaining assembly FRA₂ can comprise a plurality of retention members that can also be spaced apart from each other and positioned relative to each other such that an end of a cable to be stored can be placed between and held by those respective retention members. In the embodiment shown, two upper retention members can extend outward from an exterior side 76A of the first holding wall 70A. These upward retention members can be in the form of hooks 78A. The retention members can also comprise a lower retention member in the form of the base extension 80 that can extend outward from the first end 64 of the body 62. For example, in some embodiments, the base extension 80 can extend from the exterior side 76A of the first holding wall 70A. An end of a cable can be placed under the downward facing hooks 78A and on top of a retaining surface 82 of the base extension 80 to hold the end of the cable in place while portions of coils of cable are placed within the holding chamber HC.

Similarly, the plurality of second retention members can comprise upper retention members in the form of downward facing hooks 78B that extend outward from an exterior side 76B of the second holding wall 70B. The plurality of retention members can also comprise a lower retention member in the form of a head extension 90 that can extend outward from the second end 66 of the body 62. For example, in some embodiments, the head extension 90 can extend outward from the second holding wall 70B below the hooks 78B. A second end of the cable being stored can be placed under the hooks 78B and on top of a retention surface 92 of the head extension 90 to retain the second end of the cable either before the portions of coils of the cable are placed within the holding chamber HC or after the portions of coil of the cable are placed within holding chamber HC. In this manner, by holding or retaining both ends of the cable, the cable is prevented from knotting after the coils are placed within the holding chamber HC. In particular, in the embodiment shown in FIGS. 1A and 1B, the hooks 78A and 78B can extend outward from the extension arms 75A and 75B formed by the first and second holding walls 70A and 70B. While the hooks 78A and 78B can face downward toward the one or more lower retention members, these hooks 78A and 78B do not have to extend back underneath the upper portion of the respective hook 78A, 78B.

In such embodiments as shown in FIGS. 1A-1D, the first and second holding walls 70A and 70B can extend outward radially from the elongate body 62 to form extension arms 75A and 75B, respectively, on each side of the elongate body 62. Thereby, the first and second holding walls 70A and 70B can form a semi-circular fan-shaped plate. Due to the fan shape of the first and second holding walls 70A, 70B, support ribs 69 can extend from the receiving side 68A of the elongate body 62 at the first and second ends 64, 66 and up the respective first and second holding walls 70A, 70B. For example, the support ribs 69 can extend up the interior sides 74A, 74B of the respective first and second holding walls 70A, 70B. The support ribs 69 can fan outward from the elongate body 62 upward toward the top surface or the outward edges of the respective first and second holding walls 70A, 70B on the extension arms 75A, 75B. In this manner, the first and second holding walls 70A, 70B can be supported and strengthened to allow them to hold the portions of the coiled cable and support the weight of the cable as needed within the holding chamber HC.

To secure the portions of coils, such as loops, of the cable within the holding chamber HC, a securement strap 50 can be provided to secure the portions of coils of the cable within the holding chamber HC of the cable organizer apparatus 60 shown in FIGS. 1A-1D. The securement strap 50 can be provided that wraps over a top portion of the first and second holding walls 70A and 70B as shown in FIG. 1E. For example, the first and second holding walls 70A and 70B can define respective guide indentions, or guide wells, 72A and 72B (see FIG. 1A) that can receive portions of the securement strap 50 that can be wrapped over the top of the holding chamber HC to enclose the holding chamber HC after the portions of coils of the cable are placed therein. Thus, the securement strap 50 can extend around a portion of the cable organizing apparatus 60 to create a loop. In such embodiments, a strap aperture 84 can be formed in the base extension 80 and a strap aperture 94 can be formed in the head extension 90. The securement strap 50 can have a first end that is inserted through the base strap aperture 84 and a second end that is inserted through the head strap aperture 94. The first end of the strap 50 can then be brought up around the top portion of the first holding wall 70A and placed within the guide well 72A while the second end of the strap 50 can be inserted through the head strap aperture 94 and placed within the guide well 72B of the second holding wall 70B. The first and second ends of the strap 50 can then be secured together as shown in FIG. 1E. In some embodiments, the securement strap 50 can comprise a hook and loop fastener at least on a portion of the strap, such as the first and second end, so that the first end and the second end fasten when pressed together. In such embodiments, a middle portion of the securement strap 50 can be secured to a bottom side of the elongate body 62 so as to prevent the strap 50 from being easily lost as a separate member from the rest of the cable organizer apparatus 60.

As shown in FIGS. 1A and 1B, the head extension 90 can also comprise a hanger 96 that permits the cable organizer apparatus 60 to be hung on a hook or nail on a wall for storage. In the embodiment shown, the hanger 96 can be in the form of a loop that has an aperture 98 therethrough for receiving a hook or nail. In some embodiments, the hanger 96 can comprise some other construction, such as a hook.

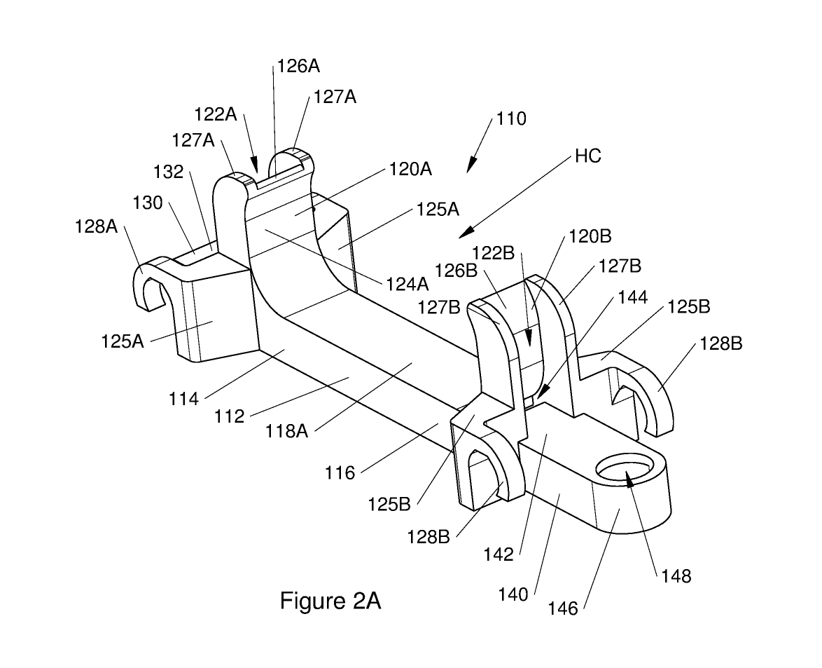

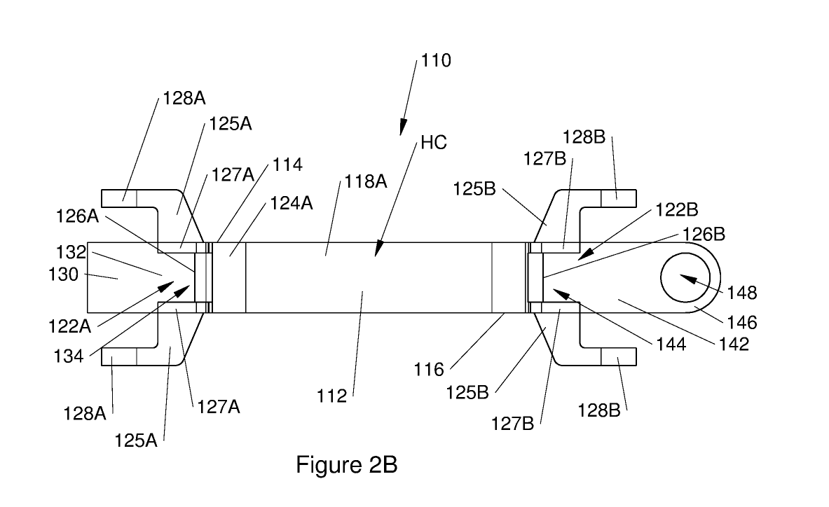

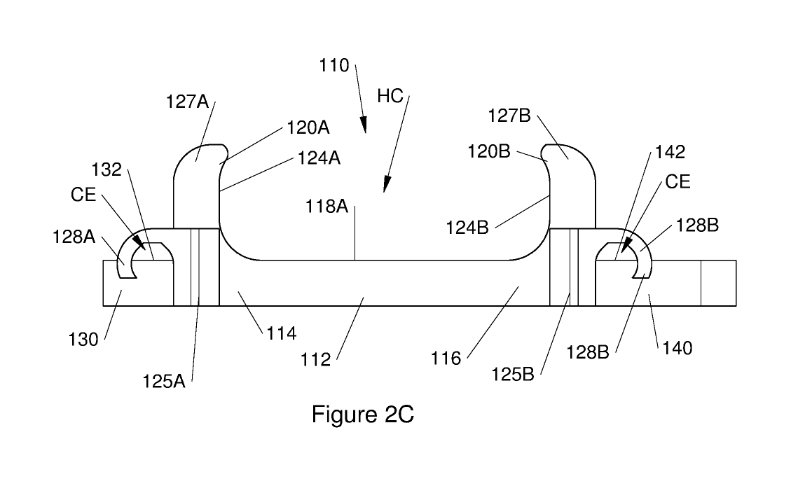

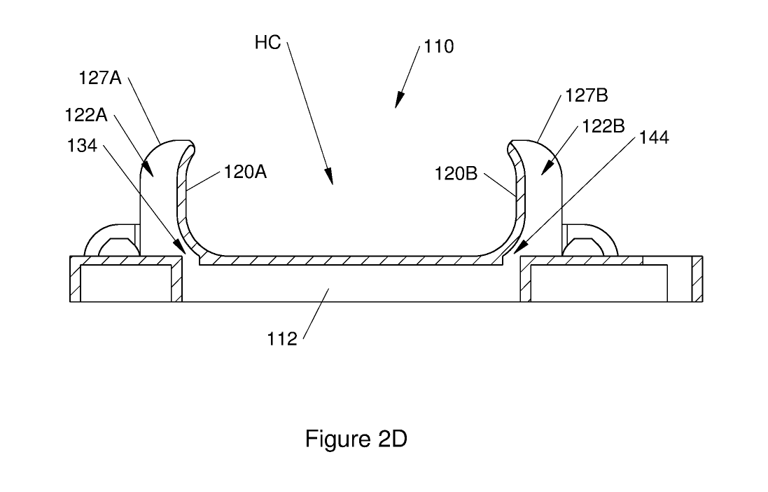

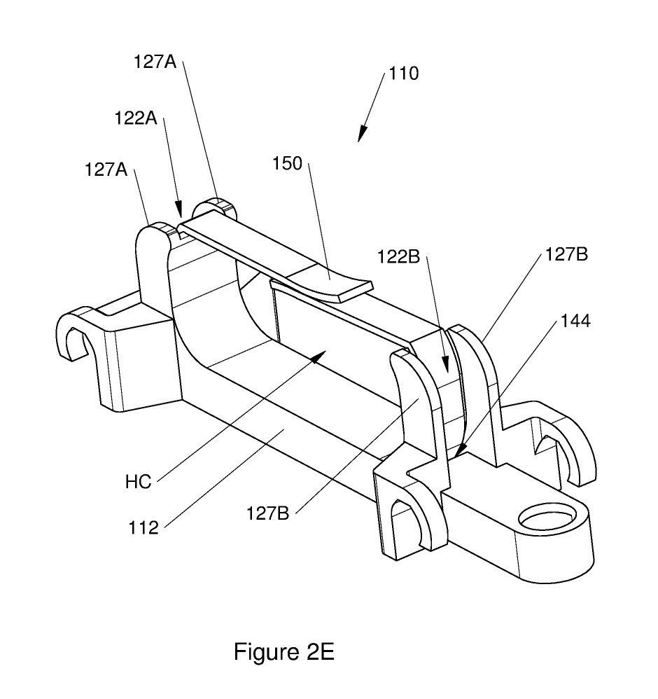

FIGS. 2A-2D show another embodiment of a cable organizer apparatus, generally designated 110. As with the previous embodiments, the cable organizer apparatus 110 can comprise an elongate body 112 having a first end 114 and a second end 116 as well as a receiving side 118A. The cable organizer apparatus 110 can also comprise a slender wall structure 120A that can extend upward from the first end 114 and a similar slender wall structure 120B can extend upward from the second end 116 of the elongate body 112. As above, interior sides 124A and 124B of the first and second holding walls 120A and 120B and the receiving side 118A of the elongate body 112 can form the holding chamber HC for receiving the cable, such as an extension cord. The first holding wall 120A can comprise an exterior side 126A which has a pair of guide walls 127A that extend about perpendicular to the exterior side 126A and about parallel to each other. Similarly, the second holding wall 120B can comprise an exterior side 126B that has a pair of guide walls 127B that extend outward from the exterior side 126B of the second holding wall 120B. The guide walls 127B can also extend about perpendicular to the exterior side 126B and about parallel to each other. In this manner, the first guide walls 127A can form a first guide well 122A and the second guide walls 127B can form a second guide well 122B. The guide well 122A that are formed by the guide walls 127A can extend down to an insertion aperture 134 that is formed by a base extension 130 as shown in FIGS. 2B and 2D. Similarly, the guide well 122B formed by the guide walls 127B can extend downward to an insertion aperture 144 that is formed by a head extension 140 as shown in FIGS. 2A, 2B, and 2D.

The base extension 130, for example, can extend outward from the first end 114 of the elongate body 112. The base extension 130 along with hooks 128A form a plurality of retention members that can hold an end of the cable to be maintained by the cable organizer apparatus 110. For example, the base extension 130 can comprise a lower retention member and the downward facing hooks 128A can form upward retention members. An end of the cable, such an extension cord, can be placed under the hooks 128A and overtop of a retention surface 132 so that the end extends through a pathway CE as seen in FIG. 2C. The hooks 128A can be supported on either side of the base extension 130 by wing supports 125A. Similarly, the head extension 140, for example, can extend outward from the second end 116 of the elongate body 112. The head extension 140 and hooks 128B can form a second set of retention members for holding a second end of a cable, such as an extension cord therebetween. For example, the head extension 140 can form a lower retention member and the downward facing hooks 128B can form upper retention members with a cable end fitting under the downward facing hooks 128B and extending above a retention surface 142 of the head extension 140. The hooks 128B can be supported on either side of the head extension 140 by wing supports 125B. The shape of the bracing hooks 128B and the position of the retention surface 132 of the head extension 140 can form a pathway CE through which the end of a cable can extend and be held therein. The clearance and size of the pathways CE can be such that an end of the cable place therein will be held by the respective retention members through a frictional engagement.

Once coiled portions of the cable are place within the holding chamber HC formed by the receiving side 118A of the elongate body 112 and the interior sides 124A and 124B of the first and second holding walls 120A and 120B, a securement strap 150 can be place around the holding chamber HC to enclose the holding chamber HC and hold the portions of the coiled cable therein. The securement strap 150 similar to the one shown in FIG. 1E can be placed such that a first end can be inserted through the insertion aperture 134 and up through the guide well 122A and a second end can be inserted through the insertion aperture 144 and within guide well 122B such that the securement strap 150 can be held securely by the cable organizer apparatus 110. The securement strap 150 can be secured together (as shown in FIG. 1E) over the opening of the holding chamber HC. By having the guide wells 122A and 122B aligned and feeding into the respective insertion apertures 134, 144, the strap 150 can be placed completely around the exterior of the portion of the cable organizer apparatus 110 that forms the holding chamber HC. In such an embodiment, the strap 150 does not extend around the ends of the cable that are held within the retention members at either end of the cable organizer apparatus 110. In such an embodiment, the guide wells 122A, 122B and the elongate body 112 form a securement strap chamber within which the securement strap 150 can extend. As with the previous embodiments, the securement strap 150 can be secured to the elongate body 112 so that the securement strap 150 is not a separate piece of the apparatus 110 and therefore is less likely to be lost.

Similar to the embodiment shown in FIGS. 1A-1D, the head extension 140 as shown in FIGS. 2A-2D can also comprise a hanger 146 that permits the cable organizer apparatus 110 to be hung on a hook or nail on a wall for storage. In the embodiment shown, the hanger 146 can be in the form of a loop that has an aperture 148 therethrough for receiving a hook or nail. In some embodiments, the hanger 146 can comprise some other construction, such as a hook.

Referring to FIGS. 3A-3F, another embodiment of a cable organizer apparatus generally designated 160 is provided. The cable organizer can comprise a base 160A (shown separately in FIG. 3D) and an arm 160B (shown separately in FIG. 3E). The cable organizer apparatus 160 is different from the previous cable organizer apparatuses presented in that arm 160B, which in the embodiment shown comprises an enclosure arm 200, is provided that can enclose a holding chamber HC. The base 160A of the cable organizer 160 can comprise elongate body 162 having a first end 164 and the second end 166 as well as a receiving side 168A. The base 160A of the cable organizer 160 can also comprise a first holding wall 170A can curve upwards from the elongate body 162 at the first end 164 of the elongate body 162. The first holding wall 170A can form an interior side 174A that forms one side of the holding chamber HC. Further, the first holding wall 170A can have receiving walls 177A that form a knuckle for receiving a hinge end 202 of the enclosure arm 200. The hinge end 202 can engage the knuckle formed by receiving walls 177A of the first holding wall 170A such that the hinge end 202 of the enclosure arm 200 can pivot within the knuckle. The enclosure arm 200 can have an L-shape that can comprise an enclosure arm top wall 218 with the hinge end 202 being pivotally secured to the knuckle of the receiving walls 177A for movement of the enclosure arm 200 from an open position to a closed position as shown in FIG. 3C and an enclosure arm sidewall 214 that extends at an angle from the enclosure arm top wall 218 having a latch end 204 of the enclosure arm 200. When in a closed position, the enclosure arm top wall 218 and the enclosure arm sidewall 214 along with the interior side 174A of the first holding wall 170A and the receiving side 168A form the holding chamber HC. Between the enclosure arm top wall 218 and the arm enclosure sidewall 214, the enclosure arm 200 can comprise a flexing portion 210 that allows the enclosure arm sidewall 214 to flex inward when the latch end 204 is inserted and removed from a latch receiver of the cable organizer 160 shown in a partial cross-sectioned view SV in FIG. 3B and as explained further below.

A plurality of retention members can be provided at either end of the cable organizer apparatus 160 to securely hold the ends of the cable that is to be held and maintained by the cable organizer apparatus 160. For example, the plurality of retention members can include a lower retention member in the form of a base extension 180 that extends outward from the first end 164 of the body 162. For example, in some embodiments, the base extension 180 can extend outward on the exterior end of the first end 164 of the body 162. Arms 175A can extend outward from a side of the first holding wall 170A. A plurality of upward retention members in the form of downward facing hooks 178A can extend outward from the arms 175A on either side of the base extension 180. Similarly, a lower retention member in the form of a head extension 190 can extend from the second end 166 of the body 162 on the other side of the receiver shown in the partial cross-sectioned view SV in FIG. 3B. Arms 175B can extend from the side of the second end 166 of the body 162 as seen in FIG. 3D.

The plurality of upward retention members can extend outward from the side arms 175A, 175B. These upward retention members can comprise hooks 178B which extend outward from the arms 175B and point downward on either side of the head extension 190. As with the embodiments described above, the hooks 178A, 178B can be positioned and spaced apart relative to the respective base extension 180, and head extension 190 to create a frictional engagement once an end of a cable is placed under the respective hooks 178A, 178B and on top of a retention surface 182 or 192 of the respective base extension 180 or head extension 190. For example, to help hold ends of a cable by the retention members, retention ridge 184 can reside on the base extension 180 in front of the retention surface 182, while retention ridge 194 can reside on the base extension 190 in front of the retention surface 192.

Thus, as shown in FIG. 3F, an end E₂ of the cable C, such an extension cord, can be placed under the hooks 178A and overtop of the retention surface 182 of the base extension 180 so that the end E₂ extends through a path CE. Similarly, an end E₁ of the cable C can be placed under the hooks 178B and overtop of the retention surface 192 of the head extension 190 so that the end E₁ extends through a similar path CE as seen in FIG. 4C. In particular, the clearance and size of the pathways CE can be such that an end of the cable place therein will be held by the respective retention members through the frictional engagement mentioned above.

As shown in FIGS. 3A and 3D, the head extension 190 can form a hanger portion 196 that can form an opening that allows the cable organizer apparatus 160 to be hung from a wall. The hanger portion 196 can form an enclosure loop that forms an aperture 198 that allows the cable organizer apparatus 160 to be placed on a hook or nail within a wall of a garage or the like. Alternatively, the hanger portion 196 can be in the form of a hook that allows for the same purpose.

To allow for retention and placement of the cable within the holding chamber HC, the enclosure arm 200 can be pivoted from an open position to a closed position as shown in FIG. 3C. To create the hinge at the hinge end 202 of the arm 200, the hinge end 202, as mentioned above, which can fit within the receiving walls 177A of the first holding wall 170A. The hinge end 202 of the enclosure arm 200 can have a pivot aperture 205. The receiving walls 177A can form a knuckle into which the hinged end 202 can fit. The receiving walls 177A can have hinge apertures 173 that extend therethrough and that are aligned with each other. When the hinge end 202 of the enclosure arm 200 is inserted within the knuckle formed by the receiving walls 177A, the pivot aperture 205 aligns with the hinge apertures 173 of the receiving walls 177A so that a pivot pin 207 (see FIGS. 3B and 3C) or some other mechanism can be inserted through the pivot aperture 205 and the hinge apertures 173 to hold the hinge end 202 of the enclosure arm 200 in place and allow the enclosure arm 200 to pivotably move between an open position and a closed position.

To secure the enclosure arm 200 in a closed position to form the holding chamber HC, the latch end 204 of the enclosure arm 200 that is at the end of the enclosure arm wall 214 can engage a portion of body 162 at the end 166. For example, the end 166 of the body 162 can comprise a latch receiver having a receiver aperture 172 therein. The receiver can also comprise an engagement ridge 203 for engaging the latch end 204 in the receiver aperture 172 upon the latch end 204 on the enclosure arm 200 being inserted into the receiver aperture′172 (see FIG. 3B). The enclosure arm wall 214 of the enclosure arm 200 can have a release 206 thereon that allows the latch end 204 to be released from the latch receiver in the body 162. The latch end 204 can have a latch engagement lip 208 (see FIGS. 3B and 3E) that extends and points outward from the latch end 204 away from the holding chamber HC. The latch engagement lip 208 can lock the arm 200 in place when the enclosure arm 200 is rotated and pushed to a closed position by engaging an engagement ridge 203 (see FIG. 3B) of the latch receiver that extends into and forms a portion of the perimeter of the latch receiver aperture 172.

When rotating the enclosure arm 200 into the closed position, the latch end 204 is inserted into the receiver aperture 172, the slanted bottom portion of the latch end 204 can contact the slanted top portion of the engagement ridge 203 so that the flex portion 210 allows the enclosure arm sidewall 214 and the latch end 204 to flex inward so that latch end 204 moves into the receiver aperture 172. The latch end 204, including the latch engagement lip 208, can have a width WL. The aperture 172 can have an outer width WLR that is wider than the width WL, such that the width WLR is wide enough to receive the latch end 204 including the engagement lip 208. An inner width of the aperture 172 below the engagement ridge 203 can be wider than the outer width WL, so that, once the latch engagement lip 208 clears the end of the engagement ridge 203, The flexing portion 210 of the enclosure arm 200 moves forward so that the engagement lip 208 securely engages the engagement ridge 203. The latch end 204 can comprise tapered sides 216 as shown in FIG. 3E that narrows the tip of the latch end 204 to provide easier insertion of the latch end into the latch receiver aperture 172.

When rotating the enclosure arm 200 from the closed position to an open position, a user can press the release 206 inward toward the first holding wall 170A. The width WLR of the receiver aperture 172 is wide enough to allow the engagement lip 208 to clear the engagement ridge 203 and allow the latch end 204 to be pulled outward from the receiver aperture 172.

In some embodiments as shown in FIGS. 3A-3C and 3F, the enclosure arm 200 can also operate as a carrying handle. For example, the enclosure arm 200 can include a contoured grip 212 on the underside of the enclosure arm top wall 218. The contoured grip 212 can be on the top side of the holding chamber HC with extra space between the area in the holding chamber HC where the cable is held and the contoured grip 212 of the enclosure arm 200 so that a user can comfortably place his hand between the portions of cable within the holding chamber HC and the enclosure arm 204.

Referring to FIGS. 4A-4E, another embodiment of a cable organizer apparatus generally designated 220 is provided. The cable organizer apparatus 220 is similar to the previous cable organizer apparatus 160 (shown in FIGS. 3A-3F) and thus the references numerals are the same for many of the same features and will not be described in detail again. The cable organizer apparatus 220 provides an enclosure arm 200 that forms and encloses a holding chamber HC. The cable organizer 220 can comprise elongate body 162 having a first end 164 and the second end 166 as well as a receiving side 168A. A first holding wall 170A can curve upwards from the elongate body 162 at the first end 164 of the elongate body 162. The first holding wall 170A can form an interior side 174A that forms a sides of the holding chamber HC. Further, the first holding wall 170A can have receiving walls 177A that form a knuckle for receiving a hinge end 202 of the enclosure arm 200. The enclosure arm 200 can have an L-shape that can comprise an enclosure arm top wall 218 with the hinge end 202 being pivotally secured to the knuckle of the receiving walls 177A for movement of the enclosure arm 200 between an open position and a closed position as shown in FIG. 3C and an enclosure arm sidewall 214 that extends at an angle from the enclosure arm top wall 218 having a latch end 204 of the enclosure arm 200. When in a closed position, the enclosure arm top wall 218 and the enclosure arm sidewall 214 along with the interior side 174A of the first holding wall 170A and the receiving side 168A form the holding chamber HC. Between the enclosure arm top wall 218 and the arm enclosure sidewall 214, the enclosure arm 200 can comprise a flexing portion 210 that allows the enclosure arm sidewall 214 to flex inward when the latch end 204 (as seen in FIG. 3B) is inserted and removed from a latch receiver of the cable organizer 220. For example, as with the embodiment described above, the latch end 204 of the enclosure arm 200 that is at the end of the enclosure arm wall 214 can engage a latch receiver at the end 166 of the body 162 to secure the enclosure arm 200 in a closed position to form the holding chamber HC. A release 206 can be provided on the enclosure arm sidewall 214 that allows the latch end 204 to be released from the latch receiver in the body 162.

The cable organizer apparatus 220 can comprise different types of retaining assemblies provided on the ends of the cable organizer apparatus 220 to securely hold the ends of the cable that is to be held and maintained by the cable organizer apparatus 220 as mentioned above with the first retaining assembly FRA₁ and the second retaining assembly FRA₂. For example, the attachment of an end of the cable to the second retaining assembly FRA₂ can be a semi-permanent attachment as shown in FIG. 4E and, in some embodiments, the attachment of an end of the cable to the second retaining assembly FRA₂ can be a permanent attachment. As shown in FIG. 4E, the second retaining assembly FRA₂ can comprise a base extension 222 that extends outward from the first end 164 of the elongate body 162, for example, on the exterior side of the first holding wall 170A. The base extension 222 can comprise a recess 226 in which the second end E₂ of the cable C (see FIG. 4E) that can include the male connection of the cable C can be securely attached by straps T, such as plastic ties, that hold the cable organizer apparatus 220 to the cable C. In particular, grooves 224 can be provided on the base extension 222 in which the ties T can be securely placed to prevent the ties T from being pulled or slipped off the base extension 222. The grooves 224 can extend in the base extension 222 transverse to the recess 226. In some embodiments, the grooves 224 can extend in the base extension 222 about perpendicular to the recess 226. In this manner, the cable organizer apparatus 220 can remain with the cable C even when the cable C is unraveled from the holding chamber HC of the cable organizer apparatus 220.

At the other end 166 of the body 162, the first retaining assembly FRA₁ can comprise retention members similar to those described above can be provided. For example, a lower retention member in the form of a head extension 190 can extend from the end 166 of the body 162. Arms 230 can extend from the side of the end 166 of the body 162. A plurality upward retention members can comprise hooks 228 which extend outward from the arms 230 and point downward on either side of the head extension 190. As with the embodiments described above, the hooks 228 can be positioned and spaced apart relative to the head extension 190 to create a frictional engagement once a female end E₁ of the cable C is placed under the hooks 228 and on top of a retention surface 192 of the head extension 190. To help hold ends of a cable by the retention members, a retention ridge 194 can reside on the base extension 190 in front of the retention surface 192.

As shown in FIGS. 4A-4D, the head extension 190 can form a hanger portion 196 that can form an opening that allows the cable organizer apparatus 220 to be hung from a wall. The hanger portion 196 can form an enclosure loop that forms an aperture 198 that allows the cable organizer apparatus 220 to be placed on a hook or nail within a wall of a garage or the like. Alternatively, the hanger portion 196 can be in the form of a hook that allows for the same purpose.

The size shape and topography of the elongate body can change depending on a number of factors. These factors can include the type of material used to form the elongate body and cable organizer apparatus, the strength of the material used, the flexibility of the material used, and the cost of the material used as well as the weight of the material used.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole or in part. Furthermore, those of ordinary skill in the art will appreciate that the foregoing description is by way of example only, and is not intended to limit the present subject matter.

What is claimed is:

1. A cable organizer apparatus comprising:
a holding chamber configured to hold at least a portion of a cable therein; and
a first retaining assembly disposed adjacent the holding chamber, the first retaining assembly configured to hold a first end of the cable therein; and
a second retaining assembly adjacent the holding chamber, the second retaining assembly configured to hold a second end of the cable therein.

2. The cable organizer apparatus according to claim 1, wherein the holding chamber comprises an elongate body having a first end and a second end and a first holding wall that extends upward from the first end of the elongate body and a second holding wall that extends upward from the second end of the elongate body.

3. The cable organizer apparatus according to claim 2, wherein the first and second holding walls extend outward radially from the elongate body to form extension arms, respectively, on each side of the elongate body.

4. The cable organizer apparatus according to claim 1, wherein at least one of the first retaining assembly or the second retaining assembly comprises at least one of a semi-permanent attachment or permanent attachment to the cable.

5. The cable organizer apparatus according to claim 1, wherein the first retaining assembly allows the end of the cable to be removably held by the first retaining assembly and the second retaining assembly comprises at least one of a semi-permanent attachment or permanent attachment to the cable.

6. The cable organizer apparatus according to claim 2, wherein the first retaining assembly comprises one or more retention members disposed proximal to a first end of the holding chamber and the second retaining assembly comprises one or more of retention members disposed proximal to a second end of the holding chamber.

7. The cable organizer apparatus according to claim 6, wherein the plurality of retention members of the first retaining assembly comprise one or more first downward facing hooks that extend outward from the first end of the elongate body and a first lower retention member that extends outward from the first end of the elongate body below the one or more first downward facing hooks, the first lower retention member comprises a base extension that has a retaining surface to hold an end of a cable in place when the end of the cable is placed between the first lower retention member and the first upper retention members; and
wherein the plurality of retention members of the second retaining assembly comprise one or more second downward facing hooks that extend outward from an exterior side of the second holding wall and a second lower retention member that extends outward from the second end of the elongate body below the one or more second downward facing hooks, the second lower retention member comprises a head extension that has a retaining surface to hold an end of a cable in place when the end of the cable is placed between the second lower retention member and the second upper retention members.

8. The cable organizer apparatus according to claim 2, wherein the second retaining assembly comprises a base extension having a recess therein in which the second end of the cable can be securely attached by straps.

9. The cable organizer apparatus according to claim 8, wherein grooves extend in the base extension transverse to the recess in the base extension.

10. The cable organizer apparatus according to claim 2, further comprising a securement strap to secure the portions of coils of the cable within the holding chamber.

11. The cable organizer apparatus according to claim 10, further comprising first and second guide wells associated with the first and second holding walls, the first and second guide wells sized to receive portions of the securement strap when the securement strap is wrapped over the top of the holding chamber to enclose the holding chamber after portions of coils of a cable are placed therein.

12. The cable organizer apparatus according to claim 11, further comprising a base extension that extends outward from the exterior side of the first holding wall and a head extension that extends outward from the second holding wall, the base extension defining a base strap aperture through which a portion of the securement strap is insertable and the head extension defines a head strap aperture through which a portion of the securement strap is insertable.

13. The cable organizer apparatus according to claim 11, wherein the first guide well is formed by first guide walls extending outward from the first holding wall and the second guide well is formed by second guide walls extending outward from the second holding wall; and
wherein the first guide well formed by the first guide walls extends downward to an insertion aperture that is formed by a base extension for receiving a portion of the securement strap and the second guide well formed by the second guide walls extends downward to an insertion aperture that is formed by a head extension for receiving a portion of the securement strap.

14. The cable organizer apparatus according to claim 1, further comprising an enclosure arm that is moveable between an open position where portions of the cable are insertable into and removable from the holding chamber and a closed position where portions of the cable within the holding chamber are enclosed within the holding chamber.

15. The cable organizer apparatus according to claim 14, wherein the holding chamber comprises an elongate body having a first end and a second end and a first holding wall that extends upward from the first end of the elongate body, the enclosure arm is pivotably hinged to the first holding wall and, when in a closed position, the enclosure arm forming a top portion of the holding chamber.

16. The cable organizer apparatus according to claim 15, wherein the enclosure arm comprises an enclosure arm top wall and an enclosure arm sidewall, when the enclosure arm is in a closed position, the enclosure arm top wall comprising a top portion of the holding chamber and the enclosure arm sidewall comprising a second side of the chamber opposite a first side of the holding chamber formed by the first holding wall.

17. The cable organizer apparatus according to claim 16, wherein the enclosure arm top wall comprises a hinge end that engages a knuckle formed by receiving walls of the first holding wall such that the hinge end of the enclosure arm is pivotable within the knuckle and the enclosure arm sidewall of the enclosure arm comprises a latch end that is receivable within a receiver proximal to the second end of the elongate body to secure the enclosure arm in a closed position and is removable from the receiver to allow the enclosure arm to be moved to an open position.

18. The cable organizer apparatus according to claim 17, wherein the enclosure arm further comprises a flexing portion between the enclosure arm top wall and the enclosure arm sidewall that allows the latch end of the enclosure arm sidewall to be moved inward to be inserted into a receiver aperture in the receiver;
the latch end comprising a latch engagement lip that extends from the latch end and locks the enclosure arm in place when the enclosure arm is pushed to a closed position by engaging an engagement ridge within the receiver.

19. The cable organizer apparatus according to claim 18, wherein the enclosure arm sidewall comprises a release thereon that allows a user to push the enclosure arm sidewall inward toward the first holding wall to release the latch engagement lip from the engagement ridge.

20. The cable organizer apparatus according to claim 14, wherein the enclosure arm forms a carrying handle and the enclosure arm extends above the holding chamber to create extra space between the area in the holding chamber where the cable is to be held and an enclosure arm top wall of the enclosure arm so that a user can comfortably place his hand between the portions of cable within the holding chamber and the enclosure arm top wall the enclosure arm.

21. A cable organizer apparatus comprising:
an elongate body having a first end and a second end and a receiving side;
a first holding wall extending upward from the receiving side at the first end of the body, the first holding wall in combination with the receiving side of the elongate body forming a portion of a holding chamber for receiving sections of a cable therein for storage;
an enclosure arm pivotably secured to the first holding wall, the enclosure arm being moveable between an open position where portions of a cable are insertable into and removable from the holding chamber and a closed position where portions of the cable within the holding chamber are enclosed within the holding chamber; and
the enclosure arm comprising an enclosure arm top wall and an enclosure arm sidewall, when the enclosure arm is in a closed position, the enclosure arm top wall comprising a top portion of the holding chamber opposite a base of the holding chamber formed by the receiving side of the elongate body and the enclosure arm sidewall comprising a second side of the chamber opposite a first side of the holding chamber formed by the first holding wall.

22. The cable organizer apparatus according to claim 21, wherein the enclosure arm top wall comprises a hinge end that engages a knuckle formed by receiving walls of the first holding wall such that the hinge end of the enclosure arm is pivotable within the knuckle and the enclosure arm sidewall of the enclosure arm comprises a latch end that is receivable within a receiver proximal to the second end of the elongate body to secure the enclosure arm in a closed position and is removable from the receiver to allow the enclosure arm to be moved to an open position.

23. The cable organizer apparatus according to claim 22, wherein the enclosure arm further comprises a flexing portion between the enclosure arm top wall and the enclosure arm sidewall that allows the latch end of the enclosure arm sidewall to be moved inward to be inserted into a receiver aperture in the receiver;
the latch end comprising a latch engagement lip that extends from the latch end and locks the enclosure arm in place when the enclosure arm is pushed to a closed position by engaging an engagement ridge within the receiver.

24. The cable organizer apparatus according to claim 23, wherein the enclosure arm sidewall comprises a release thereon that allows a user to push the enclosure arm sidewall inward toward the first holding wall to release the latch engagement lip from the engagement ridge.

25. The cable organizer apparatus according to claim 21, further comprising a first retaining assembly disposed adjacent the first end of the elongate body on an exterior side of the first holding wall, the first retaining assembly configured to hold a first end of the cable therein; and
a second retaining assembly adjacent the second end of the elongate body, the second retaining assembly configured to hold a second end of the cable therein.

26. The cable organizer apparatus according to claim 25, wherein the first retaining assembly comprises a plurality of first retention members disposed proximal to a first end of the holding chamber.

27. The cable organizer apparatus according to claim 25, wherein the second retaining assembly comprises a base extension having a recess therein in which the second end of the cable can be securely attached by straps.

28. The cable organizer apparatus according to claim 27, wherein the grooves extend in the base extension transverse to the recess in the base extension.

29. A method of forming a cable organizer apparatus, the method comprising:
providing a base that comprises:
an elongate body having a first end and a second end and a receiving side;
a first holding wall extending upward from the receiving side at the first end of the body, the first holding wall in combination with the receiving side of the elongate body forming a portion of a holding chamber for receiving sections a cable therein for storage;
providing an enclosure arm comprising an enclosure arm top wall and an enclosure arm sidewall; and
pivotally securing the enclosure arm top wall to the first holding wall so that the enclosure arm is moveable between an open position where loops of a cable are insertable into and removable from the holding chamber and a closed position where loops of the cable within the holding chamber are enclosed within the holding chamber such that, when the enclosure arm is in a closed position, the enclosure arm top wall comprises a top portion of the holding chamber opposite a base of the holding chamber formed by the receiving side of the elongate body and the enclosure arm sidewall comprising a second side of the chamber opposite a first side of the holding chamber formed by the first holding wall.
